(19) United States
(12) Patent Application Publication
(10) Pub. No.: US 2021/0316773 A1
(43) Pub. Date: Oct. 14, 2021

(54) Touch It - an antimicrobial sleeve shopping cart sleeve

(71) Applicant: Marcellus Hunter, Magnolia, DE (US)

(72) Inventor: Marcellus Hunter, Magnolia, DE (US)

(21) Appl. No.: 16/843,902

(22) Filed: Apr. 9, 2020

(51) Int. Cl. B62B 5/06

(52) U.S. Cl. CPC B62B 5/06; B62B 2501/065

(57) ABSTRACT

A Systems and methods for disinfecting/sanitizing the trolley handle by means of an assembly in form of a sleeve which can be mounted to the trolley handle. The attachment comes in various designs, shapes and sizes and is in form of a hollow handle which can be attached and detached easily and indefinitely without effecting the shape and outlook of assembly.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent fides or records, but otherwise reserves all copyright rights whatsoever.

### BACKGROUND

### Field of the Invention

The present invention generally relates to shopping cart covers and more particularly to an antimicrobial sleeve shopping cart sleeve that significantly reduces common germs.

### Description of the Related Art

Many supermarkets and department stores provide their customers with conventional shopping carts of various sizes. Many of these shopping carts include a pivoting or extending child seat structure, which can be extended to provide a platform where a child may be seated. Conventionally these shopping carts are home for a various and large number of bacteria. A study of 85 random shopping carts found that 50 percent carried E. coli, while 72 percent contained coliform bacteria. The exceptionally high level of coliform bacteria suggests that fecal material may be involved in cart contamination,

Traditionally many stores now have disinfecting wipes available near their shopping carts and baskets. From US patent prior at research multiple type of patents have been found which provide advancement in shopping carts systems. For instance, a protection system for shopping carts bearing US patent 2,012,0313397A1 is issued to Michelle Carter. The patent provides a cover for a shopping cart may include a top configured to overly a basket and a handle of the shopping cart. Vertical sides may be attached to the top and may extend downwardly from the top to fit loosely over the cart.

Another patent on Versatile shopping cart seat cover bearing U.S. Pat. No. 7,100,982B2 is issued to Mia F. Lundgren. The patent relates to shopping cart seat covers for comfort and safety of one or two children when seated in the shopping cart. The present invention is particularly adaptable for providing a safe area for seating one or two children inside the extending platform of shopping carts. The present invention can be used in conjunction with any shopping cart that has a pivoting or extending platform, including large shopping carts, which are designed/made to seat two children, or smaller shopping carts, which are designed/made to seat only one child.

Another patent on Sanitary shopping cart seat cover bearing U.S. Pat. No. 6,848,743B1 is issued to Janna Collins. The patent is on a padded sanitary shopping cart child seat cover with storage pockets, a toy securing device and a four point securing system, which includes a safety belt that secures the cover and the child to the seat in the shopping cart.

A US patent 2,008,0258528A1 on a Shopping Cart Cover bearing is issued to Blue Ridge International Products Co. The patent is on a flexible fabric cover for a child seat on a shopping cart, and a combination thereof with a detachable child activity panel The detachable child activity panel includes at least a cover attachment subsystem for attaching the detachable child activity panel to a front handle-covering panel of the cover for use by a child seated in the shopping cart child seat. The detachable child activity panel is configured for use in the lap of a child seated other than in the shopping cart child seat for use when and in the event a child is so seated. A rear seat back-covering panel of the cover takes the form of an inverted pocket which fits over the seat back portion of the shopping cart to aid in securing the cover. The pocket is configured to be turned inside-out to serve as a storage pouch for the cover.

A Shopping cart seat cover bearing U.S. Pat. No. 5,238,293A is issued to Donna S. Gibson. The patent is on a cover for the seat of a shopping cart comprising a sheet of double quilted material having a first rectangular panel located at the rear end of the sheet, the bottom surface of the sheet being provided with at least one fastener strip adjacent to the rear edge of the first rectangular panel, the bottom surface of the sheet also being provided with at least one additional fastener strip spaced from the first mentioned fastener strip such that the first rectangular panel can be folded along a line which is located between the first fastener strip and the second fastener strip around the handle of the shopping cart so that the first and second fastener strips can engage one another to hold the first rectangular panel around the handle of the cart, the forward end of the sheet having a second rectangular panel, the sheet having a central panel extending between the first and second rectangular panels, the forward end being provided with an elastic strip, the second rectangular panel being folded downwardly and beneath the central panel along a fold line where the central panel connects with the second rectangular panel, the vertical side edges of the second rectangular panel being stitched to the bottom surface of the central panel, the folded-back and stitched second rectangular panel forming a pocket which is received over a portion of the cart on a pivotal back member that folds away from the handle portion of the shopping cart.

A Shopping cart cover bearing US patent 2,017,0217468A1 is issued to Munchkin Inc. The patent is on a versatile cover is described which can be secured onto a shopping cart, highchair, stroller or other similar seating apparatus. The cover is rollable into a low profile, shape with a handle, and can be unrolled to fit within a seat basket of a shopping cart or highchair.

A Shopping cart sanitizing system bearing U.S. Pat. No. 7,258,125B2 is issued to RSANECR RSANECR Inc. The present invention comprises a system and method for removing contaminates from the surface of a shopping cart such as a grocery cart. The system includes subjecting the cart to multiple stages of disinfection, including washing, sanitizing, and drying stages. A shopping cart is subjected to these stages by conveying the cart on a conveyor system past a plurality of nozzles, which are configured to provide a disinfecting fluid such as water, sanitizer or air. The invention uses sensors to detect the location of a shopping cart during the sanitizing process. The sensors provide indications of the cart's location which may be used to control the operation of the disinfecting stages on the conveyor belt.

There are multiple solutions that have been presented in prior art. However, these solutions are limited and restricted to their conventional systems. The current invention is focused on presenting an assembly which is directed to providing a custom fit, antimicrobial sleeve shopping cart sleeve to provide disinfecting/sanitizing to the shopping cart users.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a novel and improved form of attachment for shopping cart for disinfection and sanitization purposes.

It is also the primary objective of the invention to provide a method of assembling an attachment to a shopping cart. The method comprises providing at least one attachment as described herein according to various embodiments, and operatively mounting the sleeve attachment to the shopping cart.

It is another objective of the invention to provide an attachment made of durable material which can run for long time without any wear and tear.

It is also the object of the invention to provide an attachment as per its illustrative embodiment having a wide mouth for better cleaning.

It is also the object of the invention to provide an attachment with eco-friendly and shock absorbent material and with an ergonomic design.

It is further the object of invention to provide shopping cart sleeve in multiple shapes and sizes.

It is also the objective of the invention to provide a smart assembly which provide ease of use and convenience to the user.

A further object is to provide an assembly that is simple and easy to use.

It is also the objective of the invention to provide an efficient cleaning system which is highly portable and cost effective.

It is furthermore the objective of the invention to provide shopping cart sleeve which doesn't damage user's hand skin.

Thus, it is the objective to provide an attachment successively attaching to the shopping cart and provides better sanitization and is easily attachable and detachable. Other aspects, advantages and novel features of the present invention will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWING

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 is a side view of the proposed assembly according to one embodiment of the present invention;

FIG. 2 is a schematic top view as per present preferred embodiments of the invention.

FIG. 3 is an exploded view consistent with the present invention in its operating environment.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Conventionally, no area can ever be a 100% germ free environment, but they can become much healthier for everyone if, on a regular basis, they are subject to disinfecting and sanitizing. The public, however, may not be ready to have someone constantly wiping down tables, chairs, cabinets, walls, doorknobs, drinking fountains, etc. with disinfectants. Thus, the rate of germs growing at any place increases in many folds.

The present invention is directed to a shopping cart sleeve assembly which can be attached and detached to shopping cart in its conventional state.

The invention relates generally to systems and methods for sanitizing and cleaning. Anywhere a tremendous amount of people interacting on a daily basis, a user is subject to come in contact with any number of germs, viruses (cold and flu), plus things that one even can't even recognize.

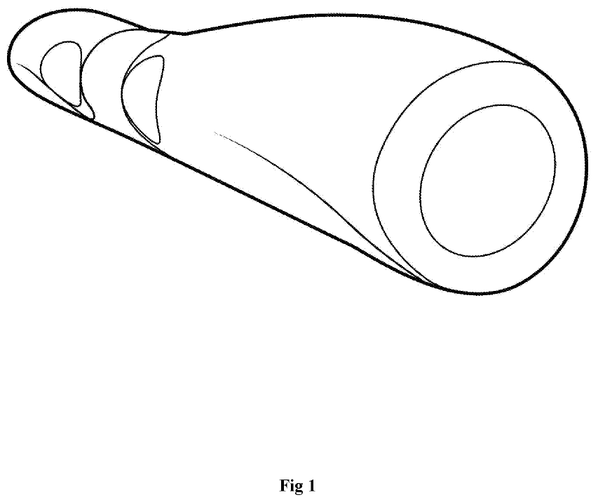

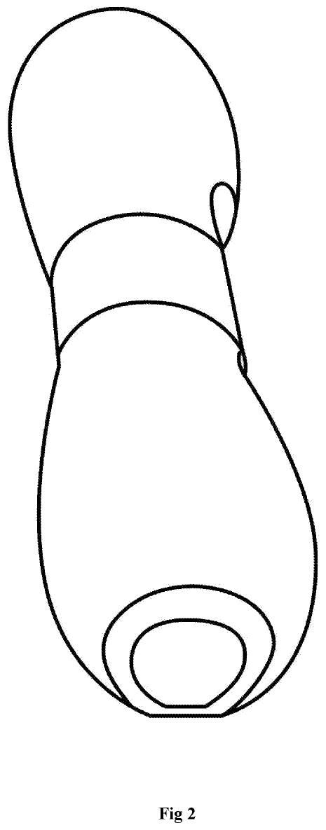

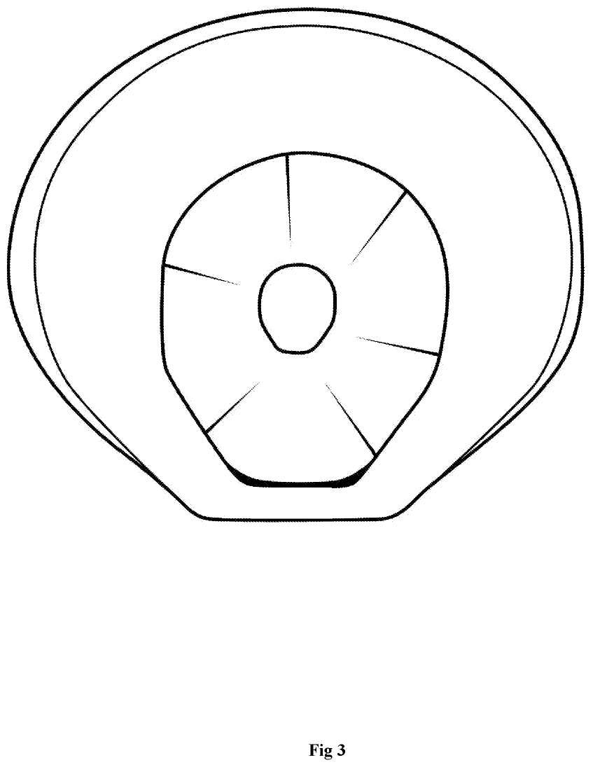

According to certain embodiments, FIGS. 1-3, depict multiple views of assembly. The FIG. 1 shows a side view of the proposed assembly according to one embodiment of the present invention where we can see the place from where we can see how the sleeve assembly can be adjusted to the trolley handle. The FIG. 2 also shows a schematic top view as per present preferred embodiments of the invention. The FIG. 3 shows an exploded view consistent with the present invention in its operating environment.

The assembly as per illustrative embodiment is made of high-quality ecofriendly material. The attachment is wide open and has a longitudinal length of 20 cm and width of 5 cm.

The assembly as per its additional embodiment's presents a hollow handle which can be attached to the shopping cart handle and can be detached easily. The process of attaching and detaching can be done multiple times regardless of any effect on assembly fitting and any compromise on efficiency of output expected.

In an embodiment, the hollow handle is lined with a thin plastic/rubber coating. First element being “directly mounted” to another element, or variants of this expression, herein refers to the first element being directly connected to another element. The direct connection may be provided by simply adjusting the attachment to trolley handle. The scraper is reinforced with the same plastic it is made from, and also presents two side support which gives added strength so as to avoid breaking while in use.

In an embodiment, the base of attachment has a rubber cap which is scored in the middle to provide better grip and stability when the sleeve inserted on the trolley handle.

In an embodiment, the sleeve is one size only and is designed to fit most commercially used trollies at everyday marts.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

I: A universal eco-friendly and shock absorbent material with an ergonomic design attachment for trolley which can fit onto any trolley handle.

II: A universal attachment for shopping trolley where:
a hollow handle;
is a plastic or rubber assembly attaching on trolley handle;
has a length of 20 cm and width of 5 cm;
hollow handle is lined with a thin plastic/rubber coating;
can be attached/detached to the trolley handle easily and indefinitely;

III: A universal shopping cart sleeve which is one size only and is designed to fit most commercially available shopping carts handles.
